(19) United States
(12) Patent Application Publication
(10) Pub. No.: US 2026/0079812 A1
(43) Pub. Date: Mar. 19, 2026

(54) DETECTING AND PREDICTING PERFORMANCE REGRESSION

(71) Applicant: Hewlett Packard Enterprise Development LP, Spring, TX (US)

(72) Inventors: Pedro H.R. Bruel, San Jose, CA (US); Eitan Frachtenberg, Portland, OR (US)

(21) Appl. No.: 18/887,920

(22) Filed: Sep. 17, 2024

(51) Int. Cl. G06F 11/34; G06F 8/41; G06F 8/77; G06F 11/00

(52) U.S. Cl. CPC G06F 11/3457; G06F 8/427; G06F 8/77; G06F 11/008

(57) ABSTRACT

In certain implementations, a system includes one or more processors and a storage storing a program for execution by the one or more processors. The program includes instructions to parse a software application to extract a semantic structure and derive static analysis metrics; collect application profiling data to detect code regions responsible for performance of the software application; and output, based on metrics of a first transformation of the software application, a variance observed during a performance simulation. The metrics of the first transformation of the software application are derived from the static analysis metrics and the detected code regions responsible for performance of the software application.

### BACKGROUND

Computer systems have become an integral part of modern life, permeating nearly every aspect of our personal and professional worlds. These computer systems come in a wide range of sizes and complexities, from individual personal computers and smartphones to vast cloud computing networks. Organizations may use on-premises computing systems housed within their own facilities, cloud-based infrastructures, and/or hybrid configurations that combine both approaches. Regardless of the setup, the operations of these computer systems primarily are implemented using software, a set of instructions that direct hardware components to perform specific tasks. Software applications may provide flexibility and adaptability of computer systems, allowing the computer systems to be customized for various applications.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 illustrates a block diagram of an example computing system for detecting and predicting performance regression, according to some implementations.

FIG. 2 illustrates a block diagram of an example system for detecting and predicting performance regression, according to some implementations.

FIG. 3 illustrates a block diagram of an example system for detecting and predicting performance regression, according to some implementations.

FIG. 4 illustrates a flowchart for an example method of detecting and predicting performance regression, according to some implementations.

FIG. 5 illustrates an example system for detecting and predicting performance regression, according to some implementations.

### DESCRIPTION

During the life cycle of a software application, the software application may undergo transformations. As examples, the transformations may include new feature additions; bug fixes; security updates; and/or other modifications to application code, external components, libraries, frameworks, and/or or other software modules. Support for new hardware, such as new central processing units (CPUs) and accelerators (e.g., graphics processing units (GPUs)), can be added and software modifications may be appropriate for such new hardware. The software transformations can impact performance. Additionally or alternatively, hardware modifications, such as updating or changing vendors of dynamic random access memory (DRAM), solid state drives (SSDs), or power supplies, may be applied to computer systems. Such hardware modifications can impact performance.

Performance regression may include a decline or degradation in the operational efficiency, speed, or overall functionality of a computing system, including any suitable combination of hardware, firmware, and software, compared to its previous state or version. Performance regression may occur when known or unknown changes to software or hardware negatively impact system performance. This negative impact to performance of the system may be observed, for example, through metrics such as memory consumption, energy consumption, and/or execution time. Such deficiencies can arise from different factors, making it relatively difficult to detect the exact cause of performance regression.

Software performance regression may include scenarios in which software operates partially or wholly correctly but performs more slowly and/or uses more resources (e.g., memory resources, processing resources, and/or other resources) than the software previously used.

Detecting and predicting performance regression may be a complex task, potentially involving relatively frequent experimentation and tracking of changes to hardware and software features. This task becomes particularly challenging and costly for software applications that run on expensive hardware and at scale. Examples of such software applications process artificial intelligence (AI) and high-performance computing (HPC) workloads.

Certain implementations of this disclosure provide techniques for detecting and predicting performance regression in a computing environment, and may use static analysis metrics along with hardware features to aid in detecting and predicting performance regression. Static analysis may include parsing a computer program to extract a semantic structure of the computer program, potentially without executing the software code. Static analysis of the code of a computer program may include examining software structure and potential behavior, potentially without execution, which may provide valuable information for predicting performance characteristics.

The hardware features may include metrics and measurements related to physical computing components. As just a few examples, the hardware features may include CPU utilization rates, memory usage statistics, storage performance metrics, network throughput, GPU utilization, power consumption data, cache hit and miss rates, and/or thermal metrics.

In certain implementations, the static analysis may use the syntax of the programming language and associated libraries to extract from the software code software features that could be relevant to performance of the computing environment. As just a few examples, the software features may include the number of memory allocations, the quantity of functions and classes, relationships between data structures, the number of function calls, and the presence and nesting of control flow structures. In some implementations, the system for detecting and predicting performance regression may associate the extracted software features resulting from static analysis with the locations in the code that correspond to those software features. The location information may assist in tracking transformation in software features.

Certain implementations may utilize application profiling data to detect software code regions of interest and may track transformations in these software code regions using static analysis metrics. As just a few examples, the static analysis metrics may include the number of modified lines, added or removed loops, and/or transformations to parallel code regions. Certain implementations may incorporate these software transformation metrics as features in a statistical performance model.

In certain implementations, a system for detecting and predicting performance regression may include a static analysis engine, an application profiler, a model building engine, and an engine for detecting and predicting performance regression. The static analysis engine may be configured to parse and analyze the source code of a software application, potentially without executing the source code. The static analysis engine may be configured to extract various metrics that may impact performance. Example metrics may include a number of memory allocations, function and class counts, data structure relationships, a function call frequency, and a control flow structure complexity. In some implementations, the static analysis engine may be configured to detect changes in data structures and their relationships, potentially providing insights into how software code transformations may impact performance.

The application profiler may be configured to collect runtime performance data. The application profiler may be configured to operate with various hardware types, including CPUs, graphic processing units (GPUs), and/or accelerators. The application profiler may run in real-time or near real-time, potentially providing relatively fast feedback on performance changes. In some implementations, the application profiler may provide detailed profiling data on memory and energy consumption. Although the application profiler may be configured to operate with any suitable computing environment, in certain implementations, the application profiler may be configured to collect profiling data from HPC environments or other complex computing environments and handle large-scale data efficiently.

The model building engine may utilize the data collected from the static analysis engine and/or the application profiler to build predictive models of software performance, e.g., statistical performance models. In some implementations, the statistical performance model may include various machine learning (ML) algorithms such as neural networks, decision trees, deep learning models, support vector machines, ensemble methods, and reinforcement learning algorithms. The algorithms of the statistical performance model may be employed to improve prediction accuracy. The regression detection and prediction engine may be configured to predict the magnitude and range of expected performance changes based on software modifications.

Certain implementations may provide none, some, or all of the following technical advantages. Certain implementations may allow for automated detection of relationships between software changes and performance regression, potentially associating changes in control flow, data structures, libraries, function calls, and algorithms with performance regression. Certain implementations may be configured to predict performance regression using software transformations while reducing or eliminating a need to perform simulations (e.g., to run experiments) in the computing environment in real-time or near real-time. Given a software transformation and possibly historic profiling data, certain implementations may predict a performance regression and potentially estimate a magnitude of the performance regression. Certain implementations may predict performance improvements resulting from software modifications.

Some implementations may automatically detect the smallest transformation in the software code that resulted in a performance change, potentially facilitating detection of the root cause of a potential regression. Certain implementations may propose how to reduce or eliminate performance regression based on a library of associations between known software transformations and performance outcomes. These potential advantages may contribute to more efficient and effective management of software performance, potentially reducing the costs and efforts associated with detecting and predicting performance regression.

Certain implementations may integrate at least partially the insights from the static analysis, profiling data, and the statistical model to provide actionable information. Certain implementations may include a user interface for visualizing performance regression data and proposed remedies; integration with version control systems (e.g., Git and APACHE SUBVERSION) to automatically track software application transformations; and a library of associations between known software application transformations and performance outcomes.

Certain implementations may propose remedies for performance regression based on the library of associations between known software application transformations and performance outcomes. In some implementations, the system for detecting and predicting performance regression may automatically apply certain proposed software application transformations. Certain implementations may help users understand and reduce or eliminate performance regression through visualizations of constraints and proposed software application transformations.

The components of the system for detecting and predicting performance regression may provide a comprehensive approach to detecting and predicting performance regression in software applications. As an example, by combining static code analysis with runtime profiling and statistical modeling, certain implementations may offer a more nuanced and/or accurate view of performance regression relative to techniques that focus primarily on hardware changes.

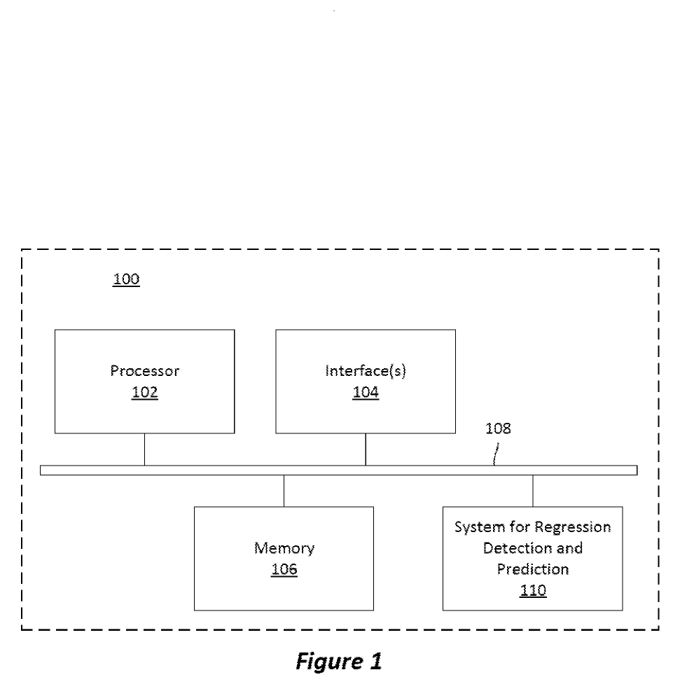

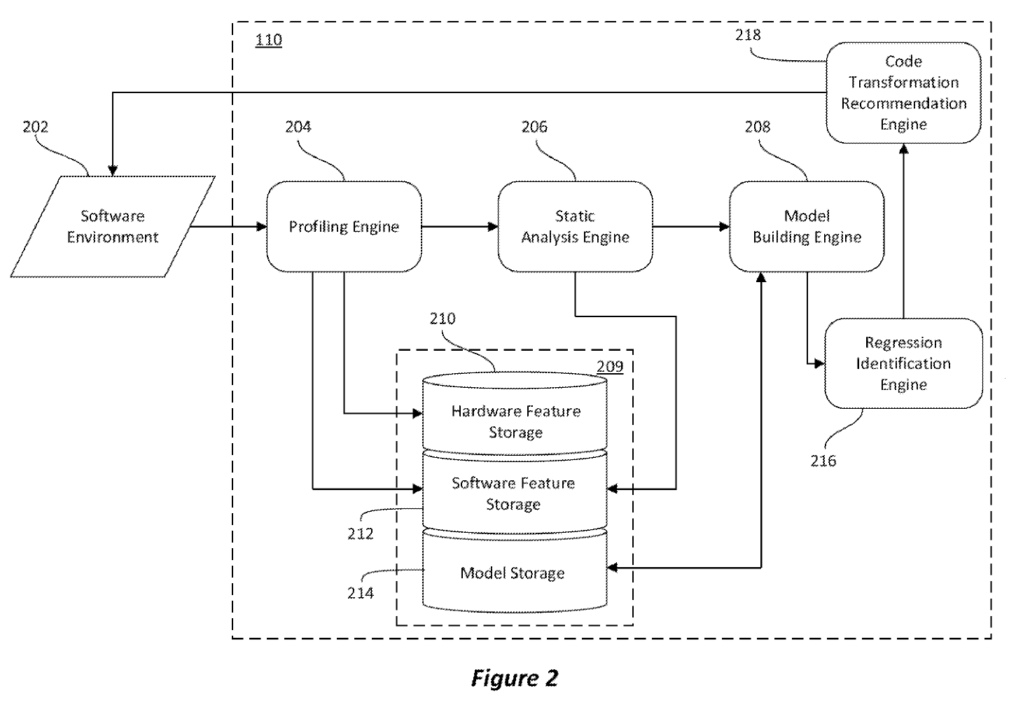

FIG. 1 illustrates a block diagram of an example computing system 100 for detecting and predicting performance regression, according to some implementations. In some implementations, the system for regression detection and prediction 110 illustrated in FIG. 1 may be an implementation of the system for regression detection and prediction 110 described below in relation to FIGS. 2-5. The computing system 100 may be implemented may include one or more electronic processing devices. Examples of electronic processing devices include servers, desktop computers, laptop computers, mobile devices, gaming systems, and/or any other suitable electronic processing devices.

The computing system 100 may be utilized in any data processing scenario. In some implementations, the computing system 100 may be used in a computing network, such as a public cloud network, a private cloud network, a hybrid cloud network, other forms of networks, or combinations thereof. In one example, the methods provided by the computing system 100 are provided as a service over a network by, for example, a third party. The computing system 100 may be implemented on one or more hardware platforms, in which the modules in the computing system 100 can be executed on one or more platforms. Such modules can run on various forms of cloud technologies and hybrid cloud technologies or be offered as a Software-as-a-Service that can be implemented on or off a cloud.

In some implementations, the computing system 100 may include a processor 102, one or more interface(s) 104, a memory 106, and a system for regression detection and prediction 110, which may be interconnected through one or more busses and/or network connections. In one example, the processor 102, the interface(s) 104, the memory 106, and the system for regression detection and prediction 110 may be communicatively coupled via a bus 108.

In some implementations, the processor 102 retrieves executable code from the memory 106 and executes the executable code. The executable code may, when executed by the processor 102, cause the processor 102 to implement any functionality described herein. The processor 102 may be a microprocessor, an application-specific integrated circuit, a microcontroller, and/or any other suitable processor.

The interface(s) 104 allow the processor 102 to interface with various other hardware elements, external and internal to the computing system 100. For example, the interface(s) 104 may include interface(s) to input/output devices, such as, for example, a display device, a mouse, a keyboard, etc. The interface(s) 104 may include interface(s) to an external storage device, or to a number of network devices, such as servers, switches, and routers, client devices, other types of computing devices, and combinations thereof.

The memory 106 may include various types of memory modules, including volatile and nonvolatile memory. For example, the memory 106 may include Random Access Memory (RAM), Read Only Memory (ROM), a Hard Disk Drive (HDD), and/or any other suitable memory. The memory 106 may include a non-transitory computer readable medium that stores instructions for execution by the processor 102. One or more modules within the computing system 100 may be partially or wholly embodied as software and/or hardware for performing any functionality described herein. Different types of memory may be used for different data storage needs. For example, in certain examples the processor 102 may boot from ROM, maintain nonvolatile storage in an HDD, and execute program code stored in RAM.

A reference is now made to the system for regression detection and prediction 110, which may parse a software application to extract its semantic structure and derive static analysis metrics. This process may involve analyzing the code structure and syntax without executing the software application.

The system for regression detection and prediction 110 may collect application profiling data to at least partially identify code regions responsible for the performance of the software application. This process may involve monitoring the application runtime behavior and resource usage.

In some implementations, the system for regression detection and prediction 110 may be configured to build and/or refine statistical performance models based on data collected from the software application. The system for regression detection and prediction 110 may process metrics related to code transformations, static analysis results, and dynamic profiling data to generate predictive models for estimating performance impacts of the software code changes.

In some implementations, the system for regression detection and prediction 110 may output a variance observed during a performance simulation, based at least on metrics of a first transformation of the software application. The metrics of the first transformation may be derived from the previously obtained static analysis metrics and the detected software code regions at least partially causing the performance regression.

Referring to FIG. 2, the figure illustrates a block diagram of an example system 110 for detecting and predicting performance regression, according to some implementations. The system for regression detection and prediction 110 may include a profiling engine 204, a static analysis engine 206, a model building engine 208, storage 209, a regression detection and prediction engine 216, and a code transformation recommendation engine 218. The system for regression detection and prediction 110 may be communicatively coupled to a software environment 202.

In some implementations, the profiling engine 204, the static analysis engine 206, the model building engine 208, the regression detection and prediction engine 216, and the code transformation recommendation engine 218, as well as the various storage components (the hardware feature storage 210, the software feature storage 212, and the model storage 214), may be combined or further separated in any suitable manner. The specific arrangement and division of the functionalities among these components as described is not limiting, and alternative implementations may distribute or consolidate these functions differently. For example, the static analysis engine 206 and the profiling engine 204 could be combined into a single analysis component, or the model building engine 208 could be further divided into separate components for different aspects of model building. The system for regression detection and prediction 110 may be implemented with more or fewer distinct components while still implementing its functionalities.

Certain implementations of the system for regression detection and prediction 110 may be configured to build one or more models for use in detecting and predicting software performance regression. The model building mode may include several stages. Initially, the profiling engine 204 may collect profiling data. This data may include various runtime metrics such as execution time, memory usage, and CPU utilization. The static analysis engine 206 may perform static analysis on the software application. The static analysis may extract relevant software code features and structures potentially without executing the software code. The model building engine 208 may construct the statistical performance model using the data previously collected. This model may be configured to predict performance impacts based on software code changes. The results from these processes may be stored in different storage components: the hardware feature storage 210 may store hardware-related profiling data; the software feature storage 212 may store software-related profiling data and static analysis results; and the model storage 214 may store the constructed statistical performance model. The detection mode may create and train the model that may be used for subsequent performance regression predictions.

The software environment 202 may represent the software application that is being analyzed for performance regression. The software environment 202 may be any software application that is executed on a computing device, such as a desktop computer, a laptop, a server, a mobile device, or any other type of computing device. The software environment 202 may include one or more software modules, libraries, or components that are executed to perform one or more tasks or functions.

In some implementations, the hardware features may include measurements and metrics related to the performance and behavior of physical components of the computing system 100. As examples, the hardware features may include CPU utilization rates, which may indicate the percentage of processor capacity being used; memory usage statistics, such as the amount of RAM consumed and memory access patterns; storage performance metrics, including read and write speeds, latency, and input/output (I/O) operations per second; and network throughput and latency measurements. In some implementations, the hardware features may include GPU utilization and memory usage for graphics-intensive applications; power consumption data; cache hit and miss rates; and thermal metrics such as temperature readings from the physical components of the computing system 100. In some implementations, the hardware features may include floating point operations per second for HPC applications and various metrics for hardware accelerators. The profiling engine 204 may collect the hardware features during runtime, providing data for the system for regression detection and prediction 110 to analyze and model the relationship between hardware performance and software behavior.

A reference is now made to the storage 209, which may include hardware feature storage 210, software feature storage 212, and model storage 214. The storage components may be implemented using various technologies, e.g., relational databases for structured data storage; NoSQL databases for flexible schema and scalability; time-series databases improved for temporal data; distributed file systems for large-scale data storage; and/or in-memory databases for high-performance data access.

The profiling engine 204 may be a software or hardware component of the system for regression detection and prediction 110 configured to collect application profiling data during runtime execution of the software environment 202 (e.g., the software application). In some cases, the profiling engine 204 may be a software module integrated directly into the application code. This integration may allow for fine-grained control over what data is collected and when.

In other implementations, the profiling engine 204 may be a module having a separate process that runs alongside the software environment 202, monitoring execution of the software environment 202 and collecting data through system-level application programming interfaces (APIs). This approach may provide a less intrusive method of profiling, potentially reducing the impact on performance of the software application during data collection.

The profiling engine 204 may be implemented as a hardware-assisted profiling tool, utilizing hardware features such as performance counters in CPUs. This implementation may provide relatively high-precision timing and low-overhead data collection for certain types of performance metrics.

In some cases, the profiling engine 204 may be a distributed system, configured for collecting and aggregating profiling data from multiple instances of the software environment 202 running across different machines or in cloud environments. This distributed approach may be beneficial for profiling large-scale applications or microservices architectures.

The profiling engine 204 may employ different profiling techniques, such as sampling-based profiling at adjustable intervals; instrumentation-based profiling for more detailed analysis; hybrid approaches combining sampling and instrumentation; and/or distributed profiling for applications running across multiple nodes.

As an example, the profiling engine 204 may incorporate sampling techniques to reduce overhead, collecting data at regular intervals rather than continuously. In some implementations, the profiling engine 204 may use instrumentation techniques, inserting software code at specific points in the software environment 202 to collect more detailed data.

In certain implementations, the profiling engine 204 may be configurable, allowing users to specify which metrics to collect and at what granularity. This flexibility may allow users to balance the trade-off between the detail of profiling data and the performance impact of data collection.

The profiling engine 204 may operate to detect software code regions of the software application responsible for performance of the software application by analyzing the collected profiling data. The profiling engine 204 allows the system for regression detection and prediction 110 to obtain real-time or near real-time feedback on performance characteristics of the software application as the software application executes.

In some implementations, the profiling engine 204 may be configured to operate in real-time or near real-time, providing relatively fast feedback on performance changes. This real-time operation may allow developers to quickly detect and reduce or eliminate performance regression as it arises.

The profiling engine 204 may collect various types of profiling data, such as the following dynamic features: execution time, memory usage, CPU utilization, I/O operations, network traffic, thread and process counts, function call frequencies, cache performance, energy consumption, and hardware resource utilization. The dynamic features may be characteristics of a software application that are observed and measured during its execution. The dynamic features may provide insights into the runtime behavior and performance of the application. In some implementations, the dynamic features may provide real-time information about the performance of the software application and behavior, which can be used in conjunction with static analysis metrics to build more comprehensive performance regression models.

As an example, the execution time may be the period of time that the operation takes for specific software code regions or the entire application to run. The memory usage may include the amount of memory consumed by the application during runtime, including peak memory usage and allocation patterns. The CPU utilization may include the percentage of CPU resources used by the application, indicating how intensively it utilizes the processor. The I/O operations may have the associated number and size of input/output operations performed by the application, such as disk reads and writes.

The network traffic may include the amount of data sent and received over the network by the application. The thread and process counts may include the number of active threads and processes created by the application, which can affect concurrency and parallelism. The function call frequencies may include the frequency how often specific functions or methods are invoked during execution. The cache performance may be metrics related to cache hits and misses, which can impact overall application speed. The energy consumption may include the amount of power used by the application during its execution. The hardware resource utilization may include usage patterns of specific hardware components such as GPUs or accelerators.

A reference is now made to the static analysis engine 206, which may be a software or hardware component configured to parse and analyze source code or compiled code of a software application potentially without executing the application. In some cases, the static analysis engine 206 may be a standalone tool that operates independently of the software environment 202. This configuration allows for flexibility in analyzing different codebases potentially without modifying the target application.

In some implementations, the static analysis engine 206 may be integrated as a plugin or extension to existing integrated development environments or software code editors. This integration may provide developers with real-time static analysis feedback as they write or modify software code.

The static analysis engine 206 may utilize abstract syntax tree parsing techniques to extract the semantic structure of the software environment 202. Such implementation may allow for a detailed understanding of the software code structure, including function definitions, variable declarations, and control flow constructs.

The static analysis engine 206 may incorporate various static analysis techniques, including control flow analysis to understand program structure; data flow analysis to track how data moves through the application; taint analysis to detect potential security vulnerabilities; symbolic execution to explore multiple execution paths; and/or abstract interpretation for more precise analysis results.

In some aspects, the static analysis engine 206 may employ data flow analysis techniques to track how data moves through the software environment 202. This analysis may help detect potential performance bottlenecks or inefficiencies in data handling.

The static analysis engine 206 may include ML algorithms to improve the ability of the static analysis engine 206 to detect patterns and a potential regression in the software code. These algorithms may be trained on large codebases to recognize common performance anti-patterns or security vulnerabilities.

In certain implementations, the static analysis engine 206 may support multiple programming languages such as C++, Java, and Python. This multi-language support allows for comprehensive analysis of a software environment 202 that may include components written in different languages.

The static analysis engine 206 may include a rules engine that allows users to define custom static analysis rules tailored to their specific project requirements or coding standards. This flexibility allows organizations to implement their own best practices and performance guidelines.

In some cases, the static analysis engine 206 may be configured to work in a distributed or parallel computing environment. This configuration allows for efficient analysis of large codebases by distributing the workload across multiple processors or machines.

In some implementations, the system for regression detection and prediction 110 uses static analysis metrics along with the hardware features (e.g., CPU usage, memory consumption, and/or execution time). Static analysis involves parsing a computer program to extract its semantic structure potentially without running the program, thereby providing valuable insights into the potential behavior and performance of the software. By using application profiling data to detect software code regions of interest and tracking changes in these code regions using static analysis metrics, the system for regression detection and prediction 110 provides a more comprehensive approach to detecting and predicting performance regression.

The static analysis engine 206 may extract semantic structure and derive static analysis metrics from the software code, such as the number of modified lines, added or removed loops, added or removed parallel code regions, function call frequencies, control flow complexity, and data structure relationships. The static analysis engine 206 may detect changes in software code structures between different versions of an application to provide insights into potential performance regression.

The static analysis metrics may be quantitative measurements and qualitative assessments derived from analyzing the structure, syntax, and semantics of source code or compiled code potentially without executing the software. Static analysis metrics may include counts of software code elements (e.g. lines, functions, classes), complexity measures (e.g. cyclomatic complexity), dependency analyses, control flow characteristics, and detection of specific software code patterns or anti-patterns. These metrics provide insights into the software structure and potential behavior that can be used to predict performance characteristics and/or detect areas for improvement.

As an example, if a data structure is modified in a way that increases its size or complexity, this could potentially impact the performance of the software application. By detecting these changes, the static analysis engine 206 can provide valuable information to the model building engine 208, helping to improve the accuracy of the ML models built by the model building engine 208.

The model building engine 208 may be a software or hardware component configured to construct a statistical performance model using data derived from static analysis of software code and dynamic profiling of software execution. The model building engine 208 may process metrics related to software code transformations, static analysis results, and application performance data to generate a predictive model to estimate performance regression from software code changes potentially without involving actual execution of the modified software code. The model building engine 208 may use various ML algorithms, such as neural networks, decision trees, or Gaussian processes, to establish relationships between software code characteristics and performance outcomes. The resulting model may allow the regression detection and prediction engine 216 to perform prediction of potential performance regressions or improvements based on proposed software code modifications.

The statistical performance model may be a mathematical representation constructed by the model building engine 208 that analyzes relationships between software code characteristics and runtime performance metrics. The statistical performance model may utilize historical data on software code transformations, static software code features, and corresponding performance measurements to predict how future software code changes may impact software performance. The statistical performance model may provide probabilistic estimates of performance changes, including potential regressions or improvements, along with associated confidence intervals and/or uncertainty measures.

The model building engine 208 may utilize different types of statistical and ML models, such as neural networks for complex non-linear relationships; decision trees for interpretable predictions; support vector machines for high-dimensional data; ensemble methods such as random forests or gradient boosting; and/or Bayesian models for uncertainty quantification.

A reference is now made to the regression detection and prediction engine 216, which may be a software or hardware component configured to analyze performance data and software code changes to detect potential performance regressions in a software application. In some cases, the regression detection and prediction engine 216 may utilize machine learning algorithms to analyze the statistical performance models stored in the model storage 214 and detect potential performance regressions.

The regression detection and prediction engine 216 may receive input in the form of new software code versions or changes to the software environment 202. Using this input, the regression detection and prediction engine 216 may extract relevant features and metrics using the static analysis engine 206. These extracted features may then be compared against the learned relationships stored in one or more of the statistical performance models.

In some implementations, the regression detection and prediction engine 216 may employ various statistical techniques to detect anomalies or deviations from expected performance patterns. For example, the regression detection and prediction engine 216 may use outlier detection algorithms to detect software code changes that are likely to result in relatively significant performance regressions.

The regression detection and prediction engine 216 may incorporate historical performance data and trends to improve its prediction accuracy. By analyzing patterns in past performance regressions, the regression detection and prediction engine 216 may detect similar patterns in new software code changes that may lead to performance regression.

In some cases, the regression detection and prediction engine 216 may provide a confidence score and/or probability estimate along with its predictions. This may help developers prioritize which potential regressions to reduce or eliminate first, based on their likelihood and potential impact on overall system performance.

The regression detection and prediction engine 216 may be configured to perform various functions related to detecting and predicting performance regressions in software applications. In some cases, the regression detection and prediction engine 216 may analyze performance data and software code changes to detect potential performance regression. The regression detection and prediction engine 216 may use statistical models and machine learning algorithms to compare metrics derived from static analysis and profiling data against historical performance baselines.

The regression detection and prediction engine 216 may be configured to output, based at least on metrics of a first transformation of the software environment 202, a variance observed during a performance simulation. The metrics of the first transformation of the software environment 202 may be derived from the static analysis metrics and the detected software code regions responsible for performance of the software application.

The metrics of the first transformation, e.g., the transformation performed during a detection mode, may be quantitative measurements derived from changes made to the software environment 202. The metrics of the first transformation may measure various aspects of the software code modifications, such as the number of lines changed, alterations to control flow structures, and/or modifications to data access patterns. The metrics of the first transformation may be derived by the regression detection and prediction engine 216 comparing the static analysis results of the original software code to the static analysis results of the transformed software code, as well as by analyzing relationships between these changes and the software code regions detected through profiling as such that impact performance.

The variance observed during a performance simulation represents the degree of deviation in performance metrics when the transformed software code is simulated or executed in a controlled environment. This variance may include changes in execution time, memory usage, CPU utilization, or other relevant performance indicators.

In some cases, the model building engine 208 may construct statistical models that capture the expected value of performance metrics and their distribution characteristics. These models may be trained using historical data collected by the profiling engine 204, which may include detailed performance profiles across various execution scenarios.

The regression detection and prediction engine 216 may use the models to analyze proposed code changes and predict potential shifts in the performance distribution. For example, the regression detection and prediction engine 216 may detect situations where a code change does not significantly alter the mean performance but impacts the variance or introduces new modes in the performance distribution.

In some implementations, the system for regression detection and prediction 110 may employ techniques such as quantile regression or distribution modeling to capture such performance effects. These approaches may allow the system for regression detection and prediction 110 to predict changes in specific percentiles of the performance distribution, such as improvements or degradations in tail performance (e.g., 95th or 99th percentile latency).

By outputting this variance based on the transformation metrics, the regression detection and prediction engine 216 may provide insights into how specific software code changes may affect the software performance. In some implementations, the regression detection and prediction engine 216 can use this information to predict potential performance regressions or improvements potentially without the need for relatively extensive real-world testing.

The code transformation recommendation engine 218 may use the detailed performance regression analysis to provide more comprehensive recommendations. In some implementations, the code transformation recommendation engine 218 may suggest code modifications that may improve average performance and/or reduce performance variability or mitigate worst-case scenarios.

In some aspects, the regression detection and prediction engine 216 may employ ML techniques to improve detection of performance regressions that may not be immediately apparent. As an example, the regression detection and prediction engine 216 may relatively continuously learn from new data to refine its predictive capabilities over time.

The regression detection and prediction engine 216 may provide detailed reports on detected performance regressions, including the specific software code changes or regions responsible for the regression, the expected magnitude of the performance impact, and recommendations for potential remediation strategies. These reports may assist developers to relatively quickly detect and reduce or eliminate performance regression before it impacts end-users.

Deriving the transformation metrics and predicting performance impacts based on software code transformations allows developers and system administrators to anticipate performance changes before deploying new software code, potentially saving time and resources in the software development and maintenance process.

The code transformation recommendation engine 218 may be a software or hardware component configured to generate recommendations for modifying the software code (e.g., a source code) to reduce or eliminate detected performance regressions or potential performance regression. In some implementations, the code transformation recommendation engine 218 may analyze the output from the regression detection and prediction engine 216 and the statistical performance model to generate targeted recommendations for improving performance of the software code.

The code transformation recommendation engine 218 may utilize a library of known software code transformations and their associated performance regression stored in the model storage 214. This library may be updated based on new data and insights gained from analyzing various software applications and their performance characteristics.

In some cases, the code transformation recommendation engine 218 may employ ML algorithms to detect patterns in software code structures that correlate with improved performance. The ML algorithms may analyze historical data on successful software code improvements to generate more accurate and/or context-specific recommendations.

The code transformation recommendation engine 218 may provide recommendations in various forms, such as specific software code modifications, refactoring recommendations, and/or higher-level architectural changes. These recommendations may be prioritized based on their predicted impact on performance and the confidence level of the prediction.

In certain implementations, the code transformation recommendation engine 218 may be configured to automatically apply certain proposed software code transformations. This feature may allow for relatively rapid testing and validation of proposed changes, potentially accelerating the improvement of the performance.

The code transformation recommendation engine 218 may provide explanations or justifications for its recommendations, helping developers understand the reasoning behind each proposed change. This transparency may facilitate better decision-making and learning for the development team.

In some aspects, the code transformation recommendation engine 218 may integrate with version control systems and development environments, allowing it to provide recommendations in real-time or near real-time as developers write or modify software code. This integration may provide proactive performance improvement throughout the development process.

In some implementations, the system for regression detection and prediction 110 may include additional components or modules to further improve its performance regression detection and prediction capabilities. For example, the system for regression detection and prediction 110 may include a hardware monitoring module to track changes in hardware configurations, and/or a software version tracking module to keep track of updates to system libraries and drivers. These additional modules may work in conjunction with the existing components of the system for regression detection and prediction 110 to provide a more comprehensive and efficient approach to detecting and predicting performance regression.

As an example, the system for regression detection and prediction 110 may integrate with version control systems, such as Git and APACHE SUBVERSION, to automatically track software code changes. This integration allows the system for regression detection and prediction 110 to monitor the software environment for changes and automatically trigger the performance regression detection and prediction process when changes are detected. This automatic tracking of software code changes may allow the system for regression detection and prediction 110 to analyze the most up-to-date version of the software application.

In some implementations, the system for regression detection and prediction 110 may be configured to handle large-scale data efficiently. In particular, the profiling engine 204 may be configured to collect profiling data from HPC environments. HPC environments may involve the execution of relatively complex computational tasks that potentially involve significant computational resources and generate large volumes of data. The profiling engine 204 may be configured to efficiently collect and process this data, providing valuable insights into the performance of the software application in these relatively demanding environments.

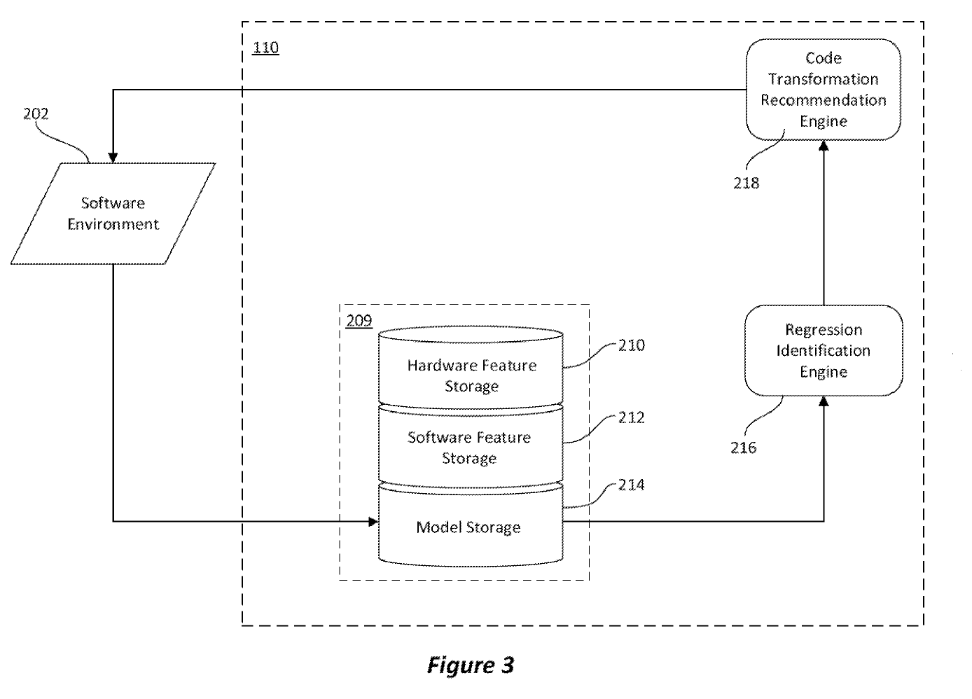

Referring to FIG. 3, the figure illustrates a block diagram of an example system 110 for detecting and predicting performance regression, according to some implementations. The system for regression detection and prediction 110 may perform prediction of regression in software applications.

To predict performance regressions, the system for regression detection and prediction 110 may use the model built in the previous detection mode described in FIG. 2. For example, the user application may be analyzed. In some implementations, the user application may be a new or modified software code. The regression detection and prediction engine 216 may use the pre-built model from the model storage 214 to predict potential performance regressions. The code transformation recommendation engine 218 may provide recommendations based on these predictions. In some cases, the code transformation recommendation engine 218 may automatically apply certain proposed software code transformations.

The prediction mode illustrated in FIG. 3 may occur potentially without running experiments on the new software code, using the knowledge captured in the model from the previous model training mode (FIG. 2). As an example, the regression detection and prediction engine 216 may be configured to detect a second transformation (additional to the first transformation described above) that cause performance regression. In some implementations, the regression detection and prediction engine 216 may detect the second transformation of the software environment 202 based on the static analysis metrics derived from the static analysis engine 206.

The second transformation may at least partially cause a performance regression. In such cases, the code transformation recommendation engine 218 may provide recommendations to reduce the performance regression based on a library of associations between known software code transformations and performance results stored in the model storage 214.

The regression detection and prediction engine 216 may be configured to predict whether a performance regression will occur and the magnitude and/or range of the expected performance change. For example, the regression detection and prediction engine 216 may predict that a certain software code transformation will result in a performance improvement of between ten percent and twenty percent. This ability to predict the magnitude and range of performance changes can provide developers with more detailed and actionable information, helping them to make more informed decisions about potential software code transformations.

The regression detection and prediction engine 216 may use the models from the model storage 214 to detect performance regressions. The regression detection and prediction engine 216 may analyze new versions or changes in the software environment 202 to predict potential performance regressions potentially without running the software code when the regression detection and prediction engine 216 uses the learned relationships between software code structures and performance metrics stored in the model storage 214. The regression detection and prediction engine 216 may output detected regressions along with associated confidence levels and/or severity ratings to guide improvement efforts.

The regression detection and prediction engine 216 may be configured to operate in real-time or near real-time, allowing for relatively continuous monitoring and early detection of potential performance regression as software code changes are made. This may allow developers to reduce or eliminate performance regressions before they impact end-users or production systems.

The regression detection and prediction engine 216 may compare static analysis metrics and profiling data from the new version of the software application against the statistical performance model to detect deviations that may indicate performance regression.

In some variations, the system for regression detection and prediction 110 may include additional components or modules. For example, the system for regression detection and prediction 110 may include a hardware monitoring module to track changes in hardware configurations, a software version tracking module to keep track of updates to system libraries and drivers, and a user interface module to provide a user-friendly interface for users to interact with the system for regression detection and prediction 110.

In some implementations, the system for regression detection and prediction 110 may be communicatively coupled to the user interface to help users understand and reduce or eliminate performance regression. The user interface may provide visualizations of constraints and proposed software code transformations, making it easier for users to understand the potential impact of different software code transformations on software performance. The user interface may provide interactive features that allow users to explore different software code transformation options and see their predicted impact on performance. The user interface may display the proposed software code changes, providing users with actionable insights to improve software performance. This can help users to make more informed decisions about how to improve their software applications.

The system for regression detection and prediction 110 may include mechanisms for data versioning and model versioning to track changes over time and provide rollback if needed. Additionally, the system for regression detection and prediction 110 may include federated learning techniques to build models across multiple distributed datasets while preserving data privacy.

The statistical performance models stored in the model storage 214 may continue to be trained with ongoing use of the system for regression detection and prediction 110. As new software versions are analyzed and performance data is collected, the model building engine 208 may incorporate this additional information to improve the accuracy and predictive capability of the models.

In some cases, the system for regression detection and prediction 110 may implement an iterative learning process. When the regression identification engine 216 makes predictions about performance regression for new software code changes, the actual performance results observed after implementation may be fed back into the system for regression detection and prediction 110. The model building engine 208 may then use this feedback to adjust and refine the models, potentially improving their accuracy for future predictions.

The profiling engine 204 and the static analysis engine 206 may relatively continuously collect new data from the software environment 202 as the software environment 202 evolves over time. This relatively ongoing data collection may allow the system for regression detection and prediction 110 to adapt to changes in the software structure, complexity, and/or performance characteristics. As an example, the model building engine 208 may periodically retrain and/or update the models using this new data, allowing the models to remain relatively accurate as the software application changes.

In some implementations, the system for regression detection and prediction 110 may employ techniques such as online learning or incremental learning algorithms. These approaches may allow the models to be updated in real-time or near-real-time as new data becomes available, potentially without the need for complete retraining of the models. This may allow the system for regression detection and prediction 110 to relatively quickly adapt to new patterns or trends in the software performance characteristics.

The code transformation recommendation engine 218 may be involved in the relatively ongoing training process. As developers implement recommended code changes and observe their impacts, the code transformation recommendation engine 218 may feed this information back into the system for regression detection and prediction 110. The model building engine 208 may use this feedback to learn the relationships between the code changes and performance regression, potentially improving the quality of future recommendations.

In some cases, the system for regression detection and prediction 110 may maintain multiple versions of the performance models, each trained on different subsets of the available data and/or using different ML algorithms. The regression identification engine 216 may compare the predictions from these different models and use, for example, ensemble techniques to generate relatively more robust and accurate predictions.

The relatively continuous training and refinement of the models may allow the system for regression detection and prediction 110 to improve its performance over time, adapting to changes in the software application, development practices, and hardware environments. This relatively ongoing learning process may improve an ability of the system for regression detection and prediction 110 to more accurately predict and/or mitigate performance regressions, potentially leading to more efficient and effective software development processes.

Having two modes, e.g., detection as described in FIG. 2 and the prediction mode, allows for efficient use of resources, as the intensive profiling and model building occur periodically rather than for every software code change. The detection and prediction modes allow relatively rapid prediction of performance impacts for new software code changes potentially without the need for extensive testing. The system for regression detection and prediction 110 can relatively continuously improve its predictive capabilities by periodically updating the model with new profiling and static analysis data.

The detection and prediction modes provide a more practical workflow for software development, where developers can get quick feedback on potential performance regression before committing or deploying software code changes.

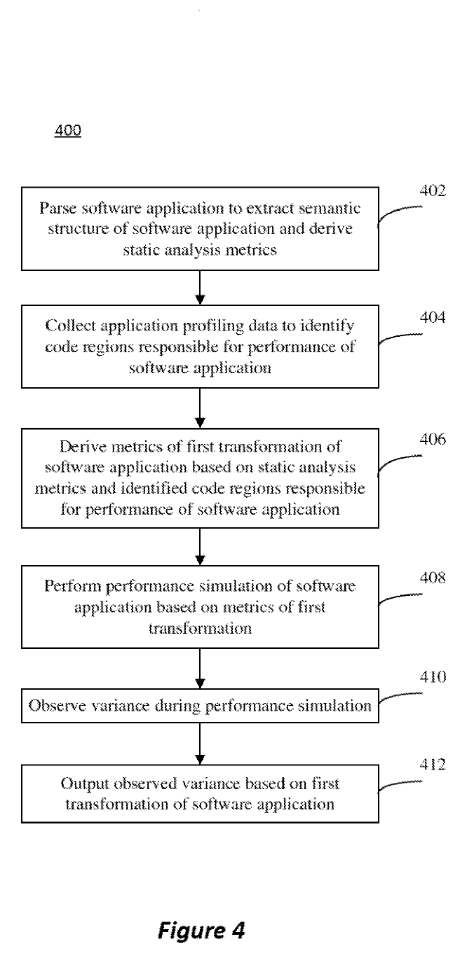

Referring to FIG. 4, the figure illustrates a flowchart for an example method 400 of detecting and predicting performance regression. More specifically, FIG. 4 illustrates a flowchart for the method 400 for detecting and predicting performance regression in software applications, according to some implementations. The flowchart begins with step 402, where the software application is parsed to extract its semantic structure and derive static analysis metrics.

In some implementations, the static analysis engine 206 is configured to parse the software environment 202 to extract a semantic structure of the software environment 202 and derive static analysis metrics. The static analysis engine 206 may extract various types of static analysis metrics, such as the number of modified lines, added or removed loops, added or removed parallel code regions, and changes in control flow structures. The static analysis engine 206 may extract other types of static analysis metrics, such as the number of memory allocations, the number of functions and classes, the relationships between data structures, the number of function calls, and the number and nesting of control flow structures.

The next step 404 includes collecting application profiling data to detect software code regions that impact the performance of the software application. The step 404 allows subsequent improvements to be focused on areas that will provide relatively substantial performance improvements. In some implementations, the profiling engine 204 may collect a variety of profiling data, which may include runtime performance metrics and/or execution statistics collected by the profiling engine 204 during execution of the software application.

In some implementations, application profiling data at least partially detects software code regions responsible for performance of the software application. The profiling engine 204 may collect various types of profiling data, such as execution time, memory usage, CPU utilization, I/O operations, network traffic, thread and process counts, function call frequencies, cache performance, energy consumption, and hardware resource utilization. The profiling engine 204 may collect this profiling data in real-time or near real-time, providing relatively fast feedback on performance changes.

In the step 406, metrics of the first transformation are derived based on the static analysis metrics and the detected critical software code regions. The step 406 integrates insights from the previous steps 402 and 404 to provide a targeted approach for software code improvement.

During the step 406, the model building engine 208 may use various types of ML algorithms, such as neural networks, decision trees, deep learning models, support vector machines, ensemble methods, and reinforcement learning algorithms, to build the statistical performance model. The model building engine 208 may use other types of statistical methods or techniques to build the statistical performance model.

In some implementations, the regression detection and prediction engine 216 uses the model stored in the model storage 214 to detect potential performance regressions. The regression detection and prediction engine 216 may analyze new versions or changes in the software environment 202 to predict potential performance regressions potentially without actually running the software code.

The next step 408 performs a performance simulation of the software application using the metrics of the first transformation. This simulation predicts the potential impacts (e.g., regression or improvement) of the proposed changes on performance of the software application.

During the next step 410, variance in the performance simulation is observed, providing feedback on the effectiveness of the simulated transformations in improving performance.

In some implementations, the step 412 outputs the observed variance based on the metrics of the first transformation of the software application. The step 412 provides a quantifiable measure of how the proposed changes may affect the performance of the software application in a real-world scenario.

In some implementations, the processor 102, the memory 106 (FIG. 1), and the interface work in conjunction with the system for regression detection and prediction 110 to carry out the steps 408, 410, and 412. In some implementations, the algorithms and data processing for the steps 408, 410, and 412 may be implemented within the system for regression detection and prediction 110

As an example, the processor 102 may execute the instructions for performing the performance simulation (step 408), observing the variance (step 410), and outputting the observed variance (step 412). In some implementations, the memory 106 may store the instructions and data for the steps 408, 410, and 412, including the software application being analyzed, the performance model, and the results of the simulation.

The regression detection and prediction engine 216 may provide output variance observed during a performance simulation. In some implementations, the interface may be used to output the observed variance (step 412), if, e.g., the results are displayed to a user or transmitted to another system (e.g., via the interface 104). The output may be presented in various formats, such as a numerical value, a graphical representation, or a textual description. The output may include additional information, such as the confidence level of the prediction, the range of possible performance impacts, or the specific software code regions that are likely to be affected.

Following the output of the observed variance, the system for regression detection and prediction 110 may proceed to additional steps based on the results. For example, if the observed variance indicates a potential performance regression, the system for regression detection and prediction 110 may trigger a software code change recommendation process. In this optional step, the system for regression detection and prediction 110 may analyze the metrics of the first transformation and the static analysis metrics to detect potential software code modifications that may mitigate the predicted performance regression. The system for regression detection and prediction 110 may then generate and output software code change recommendations based on this analysis.

In some implementations, the code transformation recommendation engine 218 generates recommendations for software code modifications to reduce or eliminate the detected performance regression. The code transformation recommendation engine 218 may provide recommendations based on a library of associations between known software code transformations and performance results stored in the model storage 214. In some cases, the code transformation recommendation engine 218 may automatically apply certain proposed software code transformations.

In some cases, the system for regression detection and prediction 110 may perform a re-simulation process. In this process, the system for regression detection and prediction 110 may apply the proposed software code changes to the software environment 202, perform a new performance simulation based on the metrics of the modified software code, and observe the variance during the new simulation. This re-simulation process allows the system for regression detection and prediction 110 to verify the effectiveness of the proposed software code changes in mitigating the predicted performance regression.

In some implementations, the system for regression detection and prediction 110 may include a feedback loop that allows for continuous improvement of the performance model. After the output of the observed variance and the above potential additional steps, the system for regression detection and prediction 110 may collect new profiling data and static analysis metrics based on the modified software code, update the metrics of the first transformation, and retrain the performance model based on the updated metrics. This feedback loop allows the system for regression detection and prediction 110 to relatively continuously learn from the changes in the software code and the corresponding changes in performance, thereby improving the accuracy and/or reliability of the performance regression predictions over time.

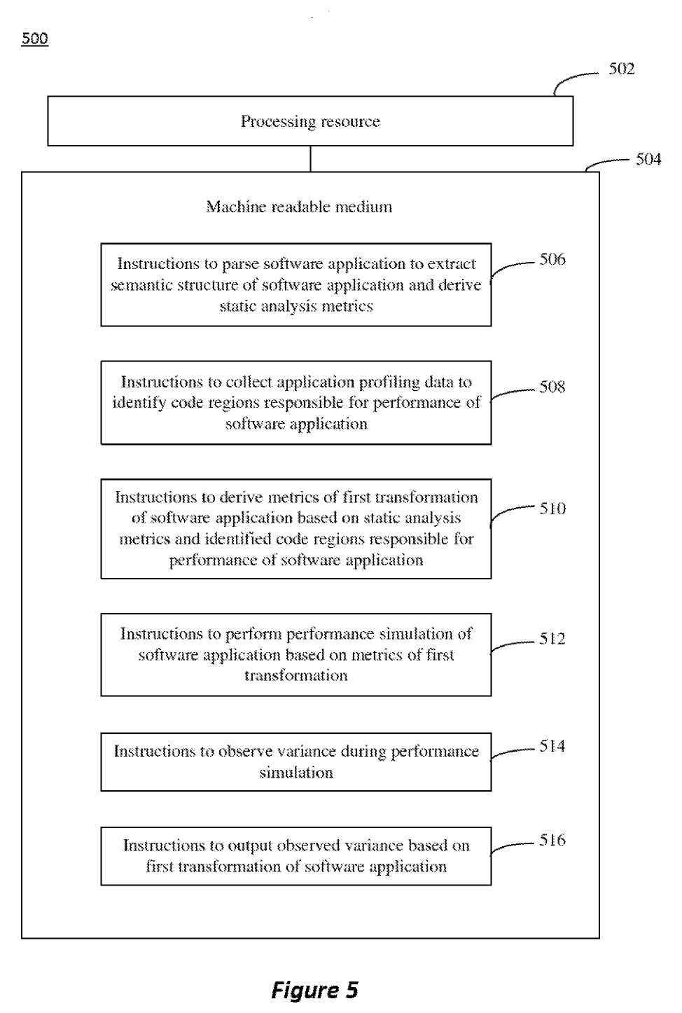

FIG. 5 illustrates an example system 500 for detecting and predicting performance regression, according to some implementations. In some implementations, the system for regression detection and prediction 500 may include a processing resource 502 and a non-transitory computer-readable medium 504 (e.g., machine readable medium).

In some implementations, the non-transitory computer-readable medium 504 may store a set of instructions 506 through 516 for regression detection and prediction. The set of instructions may include instructions for parsing the software application to extract a semantic structure and derive static analysis metrics (instructions 506), collecting application profiling data to detect software code regions responsible for performance of the software application (instructions 508), deriving metrics of a first transformation of the software application based on the static analysis metrics and the detected software code regions responsible for performance of the software application (instructions 510), performing a performance simulation of the software application based on the metrics of the first transformation (instructions 512), observing a variance during the performance simulation (instructions 514), and outputting the observed variance based on at least the metrics of the first transformation of the software application (instructions 516).

In some implementations, the processing resource 502 has access to a memory 106 (FIG. 1) and a machine readable medium 504. The machine readable medium 504 can represent any of a variety of instructions or software code that can be executable by the processing resource 502. Although described as machine readable medium, the machine readable medium 504 may be firmware and/or software in various implementations. In some implementations, the processing resource 502 can represent processing functionality of the system for regression detection and prediction 500, such as by including a microprocessor, a field-programmable gate array (FPGA), or another processing element. For example, machine readable medium 504 or instructions stored in the memory 106 can include executable code to perform various methods and operations for regression detection and prediction according to the methods and operations described herein.

In operation, system for regression detection and prediction 500 can implement various functionalities for regression detection and prediction described herein. In particular, the system for regression detection and prediction 500 can implement the method 400, such as by using instructions stored in the memory 106 or by the machine readable medium 504. For example, the memory 106 or by the machine readable medium 504 or both can store instructions, such as described in further detail below. Such instructions stored in the memory 106 or by the machine readable medium 504 can be executed by the processing resource 502.

In FIG. 5, the non-transitory computer-readable medium 504 may store programming for execution by the processing resource 502. In some implementations, the processing resource 502 can represent one or more controllers or one or more processing devices. In this implementation, one or more modules within system for regression detection and prediction 500 may be partially or wholly embodied as software for performing any functionality described in this disclosure.

For example, the machine readable medium 504 may include instructions 506 for parsing the software application to extract, by the static analysis engine 206, a semantic structure and derive static analysis metrics. In some implementations, the machine readable medium 504 may include instructions 508 to collect application profiling data from the profiling engine 204 to detect software code regions responsible for application performance. In some implementations, the machine readable medium 504 may include instructions 510 to derive, by the model building engine 208, metrics of a first transformation of the software application based on the static analysis metrics and the detected software code regions responsible for performance of the software application.

The model building engine 208 may utilize the data collected from the profiling engine 204 and the static analysis engine 206 to build a statistical performance model. This model may be stored in the model storage 214 for later use. In some implementations, the statistical performance model includes ML algorithms, such as neural networks, decision trees, deep learning, support vector machines, ensemble methods, and reinforcement learning, to improve prediction accuracy. These ML algorithms may be trained using the collected profiling data and the derived static analysis metrics, allowing the model to learn the relationships between software code changes and performance impacts.

In some implementations, the machine readable medium 504 may include instructions 512 to perform a performance simulation of the software application based on the metrics of the first transformation. In some implementations, the machine readable medium 504 may include instructions 514 to observe a variance during the performance simulation. In some implementations, the machine readable medium 504 may include instructions 516 to output the observed variance based on at least the metrics of the first transformation of the software application. In some implementations, the instructions 512, 514, and 516 may be performed by the regression detection and prediction engine 216, which may be communicatively coupled to the code transformation recommendation engine 218.

In some implementations, the software code transformation recommendation engine 218 analyzes relationships between software code structures and performance metrics to propose targeted software code transformations aimed at improving software performance. These recommendations may be derived from a library of known software code improvements and their associated performance impacts. The software code transformation recommendation engine 218 may provide recommendations in the form of specific software code modifications, refactoring recommendations, and/or higher-level architectural changes. In some implementations, the code transformation recommendation engine 218 may be configured to automatically apply certain proposed software code transformations to the software application.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. Steps may operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A system, comprising:
one or more processors;
a storage storing a program for executing by the one or more processors, the programming comprising instructions to:
parse a software application to extract a semantic structure of the software application and derive static analysis metrics;
collect application profiling data to at least partially detect code regions responsible for performance of the software application; and
output, based at least on metrics of a first transformation of the software application, a variance observed during a performance simulation,
wherein the metrics of the first transformation of the software application are derived from the static analysis metrics and the detected code regions responsible for performance of the software application.

2. The system of claim 1, wherein the programming further comprises instructions to predict performance regression using the first transformation of the software application without performing a simulation in real-time or near real-time.

3. The system of claim 2, wherein the programming further comprises instructions to provide recommendations to reduce performance regression based on a library of associations between the first transformation of the software application and an output of the performance simulation.

4. The system of claim 1, wherein the programming further comprises instructions to detect, based on the static analysis metrics, a second transformation of the software application, wherein the second transformation of the software application at least partially causes a performance regression.

5. The system of claim 4, wherein the programming further comprises instructions to provide recommendations to reduce the performance regression based on a library of associations between the first transformation of the software application and an output of the performance simulation.

6. The system of claim 1, wherein the programming further comprises instructions to predict performance regression using software changes without running experiments.

7. The system of claim 1, wherein the static analysis metrics include at least one of a number of modified lines, added or removed loops, or added or removed parallel regions.

8. A computer-implemented method, the method comprising:
parsing, by a computer system, a software application to extract a semantic structure of the software application and derive static analysis metrics;
collecting, by the computer system, application profiling data to at least partially detect code regions responsible for performance of the software application;
deriving, by the computer system, metrics of a first transformation of the software application based on the static analysis metrics and the detected code regions responsible for performance of the software application;
performing, by the computer system, a performance simulation of the software application based on the metrics of the first transformation;
observing, by the computer system, a variance during the performance simulation; and
outputting, by the computer system, the observed variance based on at least the metrics of the first transformation of the software application.

9. The computer-implemented method of claim 8, further comprising:
predicting performance regression using the first transformation of the software application without performing a simulation in real-time or near real-time.

10. The computer-implemented method of claim 9, further comprising:
providing recommendations to reduce performance regression based on a library of associations between the first transformation of the software application and an output of the performance simulation.

11. The computer-implemented method of claim 8, further comprising:
detecting, based on the static analysis metrics, a second transformation of the software application, wherein the second transformation of the software application at least partially causes a performance regression.

12. The computer-implemented method of claim 11, further comprising:
providing recommendations to reduce the performance regression based on a library of associations between the first transformation of the software application and an output of the performance simulation.

13. The computer-implemented method of claim 8, further comprising:
predicting performance regression using software changes without running experiments.

14. The computer-implemented method of claim 8, wherein the static analysis metrics include at least one of a number of modified lines, added or removed loops, or added or removed parallel regions.

15. A non-transitory computer-readable medium storing programming for execution by one or more processors, the programming comprising instructions to:
parse the software application to extract a semantic structure of the software application and derive static analysis metrics;
collect application profiling data to at least partially detect code regions responsible for performance of the software application;
derive metrics of a first transformation of the software application based on the static analysis metrics and the detected code regions responsible for performance of the software application;
perform a performance simulation of the software application based on the metrics of the first transformation;
observe a variance during the performance simulation; and
output the observed variance based on at least the metrics of the first transformation of the software application.

16. The non-transitory computer-readable medium of claim 15, wherein the one or more instructions further cause the device to:
predict performance regression using the first transformation of the software application without performing a simulation in real-time or near real-time.

17. The non-transitory computer-readable medium of claim 16, wherein the one or more instructions further cause the device to:
provide recommendations to reduce performance regression based on a library of associations between the first transformation of the software application and an output of the performance simulation.

18. The non-transitory computer-readable medium of claim 15, wherein the one or more instructions further cause the device to:
detect, based on the static analysis metrics, a second transformation of the software application, wherein the second transformation of the software application at least partially causes a performance regression.

19. The non-transitory computer-readable medium of claim 18, wherein the one or more instructions further cause the device to:
provide recommendations to reduce the performance regression based on a library of associations between the first transformation of the software application and an output of the performance simulation.

20. The non-transitory computer-readable medium of claim 15, wherein the static analysis metrics include at least one of a number of modified lines, added or removed loops, or added or removed parallel regions.
